(19) United States
(12) Patent Application Publication
(10) Pub. No.: US 2010/0287784 A1
(43) Pub. Date: Nov. 18, 2010

(54) ELECTRIC SHAVER WITH A SWING HEAD PORTION

(76) Inventor: Yuanlin QIU, Wenzhou (CN)

Correspondence Address: RABIN & Berdo, PC, 1101 14TH STREET, NW, SUITE 500, WASHINGTON, DC, 20005, US

(21) Appl. No.: 12/464,309

(22) Filed: May 12, 2009

(51) Int. Cl. B26B 19/38

(52) U.S. Cl. 30/527

(57) ABSTRACT

The present utility model relates to an electric shaver with a swing head portion, comprising: a head portion and a body, wherein the head portion is linked with the body by a swing mechanism. When pressure is exerted on the head portion, the swing effect of the head portion is caused by the cardan shaft and a spring of the cardan shaft.

### FIELD OF THE INVENTION

This utility model relates to an electric shaver with a swing head portion

### BACKGROUND OF THE INVENTION

### Summary of the Invention

A traditional electric shaver, its head portion is fixed and can not be swung, so it is uncomfortable, and the shaving effect is poor.

The present utility model is to provide an electric shaver with a swing head portion which has simple structure, agilely swing, good shaving effect, high reliability to obviate the disadvantages existed in the traditional electric shaver that head portion is fixed and can not be swung, it is uncomfortable, and the shaving effect is poor.

The technical proposal of present utility model is as following:

Comprising: a head portion and a body, wherein the head portion is linked with the body by a swing mechanism,

the swing mechanism comprising: an upper cover board connected with the head portion; a lower cover board connected with the body; a cardan shaft and an elasticity unit of the cardan shaft, the cardan shaft go upwardly through an axle hole of the lower cover board, a sliding pin positioned sidewards on the lower end of the cardan shaft slides in the sliding chute of the wall of the axle hole of the lower cover board, an upper end of the cardan shaft is connected with the upper cover board, the elasticity unit of the cardan shaft is fixed between the lower cover board and the upper cover board.

incorporate waterproof fexible flue is provided between the upper cover board and the head portion; incorporate waterproof fexible flue is provided between the lower cover board and the body; incorporate waterproof fexible flue is provided in an inner hole of the cardan shaft

rubber lagging covers the swing mechanism positioned between the head portion and the body.

The present utility model is realized by said design and has simple structures agilely swings good shaving effects high reliability, when pressure is exerted on the head portion, the swing effect of the head portion is caused by the cardan shaft and a spring of the cardan shaft

### BRIEF DESCRIPTION OF THE DRAWINGS

Exemplary embodiments of the invention will be explained in more detail below with reference to the drawings, in which:

FIG. 1 is a structural view of the present utility model.

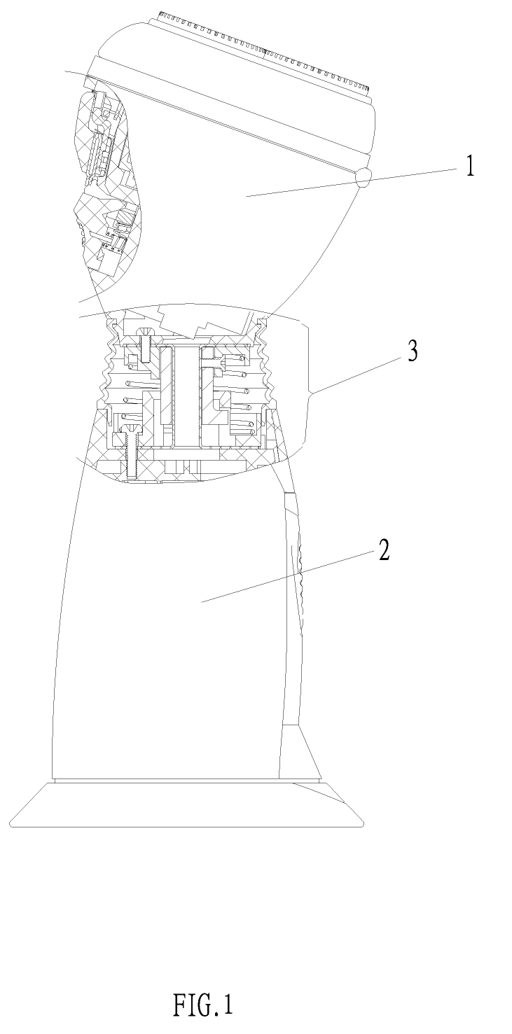

FIG. 2 is a structural view of the swing mechanism.

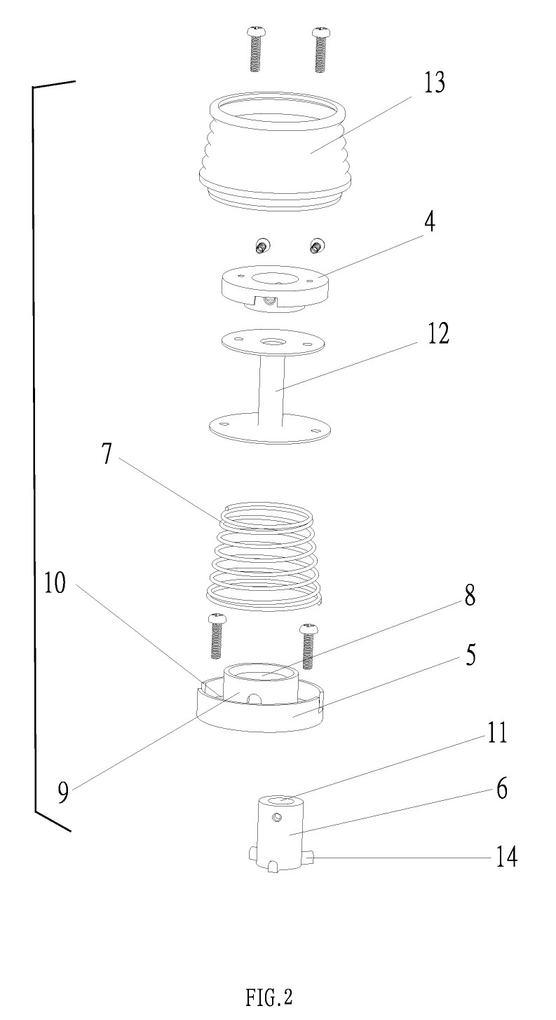

### DETAILED DESCRIPTION OF THE PREFERRED EMBODIMENTS

Referring to FIGs, the present utility model comprising: a head portion 1 and a body 2, wherein the head portion 1 is linked with the body 2 by a swing mechanism 3, the swing mechanism 3 comprising: an upper cover board 4 connected with the head portion 1; a lower cover board 5 connected with the body 2; a cardan shaft 6 and an elasticity unit 7 of the cardan shaft, the cardan shaft 6 go upwardly through an axle hole 8 of the lower cover board 5, a sliding pin 14 positioned sidewards on the lower end of the cardan shaft 6 slides in the sliding chute 10 of the wall 9 of the axle hole of the lower cover board 5, an upper end of the cardan shaft 6 is connected with the upper cover board 4, the elasticity unit 7 of the cardan shaft is fixed between the lower cover board 5 and the upper cover board 4. incorporate waterproof fexible flue 12 is provided between the upper cover board 4 and the head portion 1; incorporate waterproof fexible flue 12 is provided between the lower cover board 5 and the body 2; incorporate waterproof fexible flue 12 is provided in an inner hole 11 of the cardan shaft 6. incorporate waterproof fexible flue 12 prevents liquid from going into the head portion 1 or the body 2. Rubber lagging 13 covers the swing mechanism 3 positioned between the head portion 1 and the body 2. the Rubber lagging 13 is of protection, in the using state, when pressure is exerted on the head portion 1, the sliding pin 14 positioned sidewards on the lower end of the cardan shaft 6 and the sliding chute 10 of the wall 9 of the axle hole of the lower cover board 5 are swinging together, so the head portion 1 connected with the upper cover board 4 is swinging too, the elasticity unit 7 of the cardan shaft adopts spring or rubber block for elasticity purpose.

What is claimed is:

1. An electric shaver with a swing head portion,
Comprising: a head portion and a body, wherein the head portion is linked with the body by a swing mechanism, the swing mechanism comprising: an upper cover board connected with the head portion; a lower cover board connected with the body; a cardan shaft and an elasticity unit of the cardan shaft, the cardan shaft go upwardly through an axle hole of the lower cover board, a sliding pin positioned sidewards on the lower end of the cardan shaft slides in the sliding chute of the wall of the axle hole of the lower cover board, an upper end of the cardan shaft is connected with the upper cover board, the elasticity unit of the cardan shaft is fixed between the lower cover board and the upper cover board.

2. The electric shaver with a swing head portion according to claim 1, wherein incorporate waterproof fexible flue is provided between the upper cover board and the head portion; incorporate waterproof fexible flue is provided between the lower cover board and the body; incorporate waterproof fexible flue is provided in an inner hole of the cardan shaft.

3. The electric shaver with a swing head portion according to claim 2, wherein rubber lagging covers the swing mechanism positioned between the head portion and the body.
